(19) United States
(12) Patent Application Publication
(10) Pub. No.: US 2022/0376502 A1
(43) Pub. Date: Nov. 24, 2022

(54) METHOD AND APPARATUS FOR CONTROLLING LOADS CONNECTED TO A DISTRIBUTED ENERGY GENERATION SYSTEM

(71) Applicant: Emphase Energy, Inc., Petaluma, CA (US)

(72) Inventors: Sumit SARAOGI, Freemont, CA (US); Utsav Ghosh, San Jose, CA (US); Rohit Kumar Saraf, Madhubani (IN); Karikalan Desingurajan, Bangalore (IN); Arpit Mandloi, Madhya Pradesh (IN); Maria M.J. Alexander, Thaiyur (IN); Ayush Garg, Kota (IN); Vinod Tigadi, Bangalore (IN)

(21) Appl. No.: 17/747,682

(22) Filed: May 18, 2022

Related U.S. Application Data
(60) Provisional application No. 63/189,871, filed on May 18, 2021.

(51) Int. Cl. H02J 3/14; H02J 3/32; H02J 3/38; G06F 3/04847; G06F 3/0482

(52) U.S. Cl. CPC H02J 3/14; H02J 3/32; H02J 3/381; G06F 3/04847; G06F 3/0482; H02J 2300/24

(57) ABSTRACT

Method and apparatus for controlling loads connected to a distributed energy generation system. The method and apparatus display a list of loads, load status, load control state, where the load control state is manipulated through a user interface displayed on a user device. The load control state defines the operation of a load depending upon the operational status of the distributed energy generation system.

### RELATED APPLICATION

This application claims benefit to U.S. Provisional Patent Application Ser. No. 63/189,871 filed 18 May 2021 entitled “Method and Apparatus for Controlling Loads Connected to a Distributed Energy Generation System,” which is hereby incorporated herein by reference in its entirety.

### BACKGROUND

### Field

Embodiments of the present invention generally relate to distributed energy generation systems and, in particular, to a method and apparatus for controlling loads connected to a distributed energy generation system.

### Description of the Related Art

A distributed energy generation system typically comprises a plurality of energy generators (e.g., solar panels, wind turbines, etc.), one or more power converters (e.g., optimizers, microinverters, inverters, etc.), and a service panel to connect the system to loads and/or a utility power grid. For a solar system, the solar panels are arranged in an array and positioned to maximize solar exposure. Each solar panel or small groups of panels may be coupled to a power converter (so-called micro-inverters) or all the solar panels may be coupled to a single inverter via DC-DC optimizers. The inverter(s) convert the DC power produced by the solar panels into AC power. The AC power is coupled to the service panel for use by a facility (e.g., home or business), supplied to the power grid, and/or coupled to an optional storage element such that energy produced at one time is stored for use at a later time. Other forms of distributed energy generators include wind turbines arranged on a so-called wind farm. Storage elements may be one or more of batteries, fly wheels, hot fluid tank, hydrogen storage or the like. The most common storage element is a battery pack (i.e., a plurality of battery cells) having a bidirectional inverter coupled to the service panel to supply the batteries with DC power as well as allow the batteries to discharge through the inverter to supply AC power to the facility when needed.

The service panel may comprise a switch that enables the distributed energy system to be disconnected from the utility power grid (i.e., establish a micro-grid operating in an off-grid manner). Disconnecting from the grid may occur automatically, when the system senses a grid anomaly such as a brownout or blackout, or the grid may be purposefully disconnected to allow the facility to operate off-grid. In off-grid operation, the system supplies power to the loads from the solar panels and storage, as needed. If the solar panels generate more power than is currently required by the loads, the excess power is stored in the storage elements. During periods when the solar panels are not able to supply enough power to power the loads, power is supplied from storage to augment the power from the solar panels. If the solar panels are not producing any power, e.g., nighttime or a cloudy day, power for the loads may be supplied by the storage elements.

At times, too many loads may simultaneously require power straining the distributed power generation system's ability to supply the loads with sufficient power. To avoid such a situation, loads may simply be disconnected from the system by manually switching off a service panel breaker for that load such that some loads are not available for use during off-grid operation. Such manual control requires an operator (e.g., homeowner) to have knowledge of the loads and when each load should be disconnected from the system to ensure proper system operation.

Therefore, there is a need for a method and apparatus configured to provide improved load control for loads connected to a distributed energy generation system.

### SUMMARY

Embodiments of the present invention generally relate to a method and apparatus for controlling loads connected to a distributed energy generation system as shown in and/or described in connection with at least one of the figures.

Various features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present invention can be understood in detail, a particular description of the invention, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of distributed energy generation system configured to have a plurality of loads controlled in accordance with at least one embodiment of the invention;

FIG. 2 depicts a block diagram of a computer system that is used to control loads connected to a distributed energy generation system in accordance with at least one embodiment of the invention;

FIG. 3 depicts a flow diagram of a method that is performed upon executing a load control software application in accordance with an embodiment of the invention;

FIGS. 4, 5, 6, and 7 depict screen images on a user device used as an interface to the load control method of FIG. 3 in accordance with an embodiment of the invention; and

FIGS. 8, 9, 10, 11, 12, 13 and 14 depict screen images on a user device used as an interface to the load control method of FIG. 3 in accordance with another embodiment of the invention.

### DETAILED DESCRIPTION

Embodiments of the present invention comprise apparatus and methods for controlling loads connected to a distributed energy generation system. Embodiments of the invention utilize a software application executing on a user device to produce a user interface to the distributed energy generation system. The interface may be available on a user's mobile device, e.g., smart phone, personal digital assistant, pad device, laptop computer, notebook computer, or the like. The interface facilitates interaction with the distributed energy generation system to control loads within a facility such that the loads are optimally powered depending on the operational status of components of the distributed energy generation system.

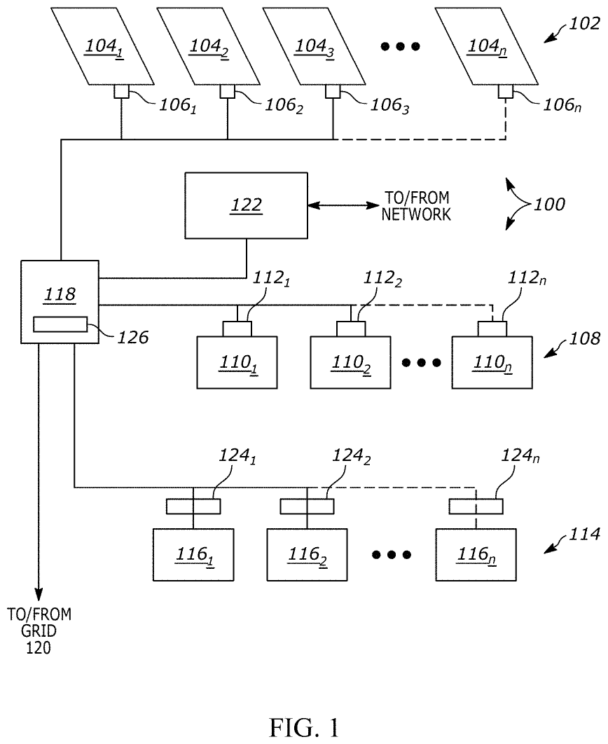

FIG. 1 depicts a block diagram of distributed energy generation system 100 that is to be commissioned in accordance with at least one embodiment of the invention. The system 100 comprises a plurality of distributed generators 102 (e.g., solar panels 104₁, 104₂, 104₃, . . . 104ₙ coupled to power converters 106₁, 106₂, 106₃, . . . 106ₙ), optional energy storage 108 (e.g., batteries 110₁, 110₂, . . . 110ₙ coupled to bidirectional power converters 112₁, 112₂, . . . 112ₙ), a service panel 118 through which the distributed generator 102 is coupled to the storage 108, and at least one gateway 122 configured to communicate with the distributed generators 102, storage 108 and a communication network (Internet). The service panel 118 is also coupled to a plurality of loads 114 represented by loads 116₁, 116₂, . . . 116ₙ. The loads 114, in a residential application, may comprise washer, dryer, refrigerator, air conditioner, well pump, hot water heater, electric vehicle, and/or any other electricity consuming device in the household. The loads 114, in an industrial application, may comprise electric motors, heating systems, air conditioning systems, refrigerators, freezers, and/or any other electricity consuming device generally used in an industrial setting. The service panel 118 may also be coupled to the power grid 120, such that, energy may be consumed from the grid 120 or sourced to the grid 120, as necessary. The service panel 118 may include and/or be connected to a switch 126 capable of disconnecting the system 100 from the grid 120 such that the system 100 and its loads 114 form a microgrid.

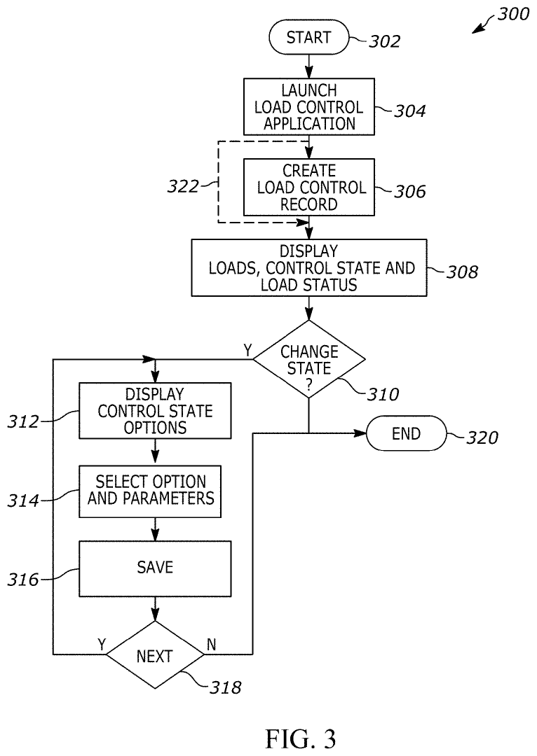

Each load 116 or select number of loads are coupled to the service panel via a load control device 124₁, 124₂, . . . 124ₙ. The load control devices 124 may be co-located with the load (i.e., at the wall socket or built into the load itself) or the devices 124 may be located in the service panel 118 or anywhere in the power circuit between the panel 118 and the loads 114. The devices 124 may be controlled by wire (e.g., separate control wiring or power line communications), wireless (e.g., WiFi or Bluetooth) or a combination of wire and wireless. The devices 124 are controllable switches or relays that connect or disconnect a load from a power source (e.g., storage, power generator and/or grid). The switching function may be controlled by the gateway 122. As shall be described below with respect to FIG. 3, embodiments of the present invention facilitate controlling loads connected to the distributed generators 102 and/or storage 108. Specifically, embodiments of the invention facilitate establishing criteria defining the operation of loads in view of the current status of the distributed energy generation system, e.g., off-grid, on-grid, generating power, power storage levels, etc.

Although FIG. 1 depicts a distributed generator 102 having a single solar panel coupled to a single power converter (i.e., micro-inverter, optimizer and the like), this depiction is not meant to limit the scope of the invention. For example, embodiments of the invention may also be used with distributed generators having a plurality or more solar panels coupled to one or more power converters. In other examples, the power converters (so called optimizers or DC-DC converters) may be coupled to a single DC-AC inverter. Furthermore, distributed generators may include other forms of energy generation such as wind turbines arranged on a so-called “wind farm.” Similarly, energy storage in a battery-based storage system is described as an example of the type of storage whose capacity is estimated using embodiments of the invention; however, other forms of energy storage may be used such as fly wheel(s), hot fluid tank(s), hydrogen storage system(s), pressurized gas storage system(s), pumped storage hydropower, fuel cells, or the like.

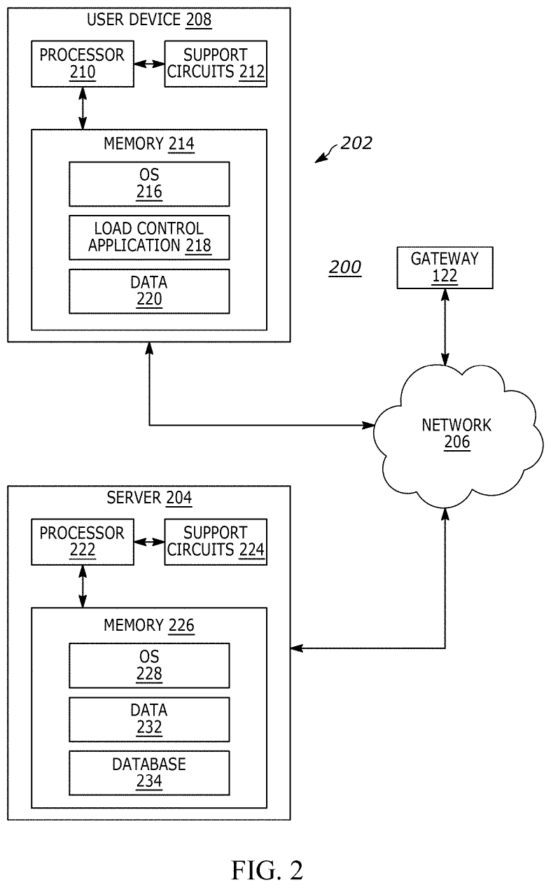

FIG. 2 depicts a block diagram of a computer system 200 supporting a load control apparatus (i.e., load controller 202) in accordance with an embodiment of the invention. The computer system 200 comprises a server 204, a computer network 206 (e.g., Internet) and at least one user device 208 (e.g., mobile phone, digital assistant, computer, or any other device capable of executing application software and displaying a user interface). In operation, the user device 208 executes an application (an “app”) and displays a user interface for user interaction. The user device 208, when executing specific software, enables the general-purposes device to operate as a specific-purpose device. Specifically, the user device operates as a load controller 202 to control the loads that are connected to a distributed energy generation system. The server 204 may provide support information (e.g., user and system profiles, login security, etc.) to the user device 208 and may also store information (e.g., load control settings) sent from the user device 208.

The user device 208 comprises at least one processor 210, support circuits 212 and memory 214. The at least one processor 210 may be any form of processor or combination of processors including, but not limited to, central processing units, microprocessors, microcontrollers, field programmable gate arrays, graphics processing units, and the like. The support circuits 212 may comprise well-known circuits and devices facilitating functionality of the processor(s). The support circuits 212 may comprise one or more of, or a combination of, power supplies, clock circuits, communications circuits, cache, and/or the like.

The memory 214 comprises one or more forms of non-transitory computer readable media including one or more of, or any combination of, read-only memory or random-access memory. The memory 214 stores software and data including, for example, an operating system (OS) 216, a load control application 218, and data 210. The operating system 216 may be any form of operating system such as, for example, Apple iOS, Microsoft Windows, Apple macOS, Linux, Android or the like. The load control application 218 may be software that, when executed by the processor(s) 210, is capable of generating a load control user interface as well as performing the load control methods in accordance with embodiments of the invention described below. The data 220 may include information to be sent to or received from the server 204.

The server 204 comprises at least one processor 222, support circuits 224 and memory 226. The at least one processor 222 may be any form of processor or combination of processors including, but not limited to, central processing units, microprocessors, microcontrollers, field programmable gate arrays, graphics processing units, and the like. The support circuits 224 may comprise well-known circuits and devices facilitating functionality of the processor(s). The support circuits 224 comprise one or more of, or a combination of, power supplies, clock circuits, communications circuits, cache, and/or the like.

The memory 226 comprises one or more forms of non-transitory computer readable media including one or more of, or any combination of, read-only memory or random-access memory. The memory 226 stores software and data including, for example, an operating system (OS) 228, data 232, and a database 234. The operating system 228 may be any form of operating system such as, for example, Apple OS X Server, Microsoft Windows Server, Linux, or the like. The data 220 may include data received from the load control application and/or any other data used by the server 204 to support operation of the load control application 218. The database 234 may contain data to support operation of the load control application 218. This data may include, but is not limited to, user profiles, load control settings/parameters, login/security information, and/or the like. The database 234 may be locally stored at the server 204 or may be remotely stored on another server or servers and accessed via the network 206.

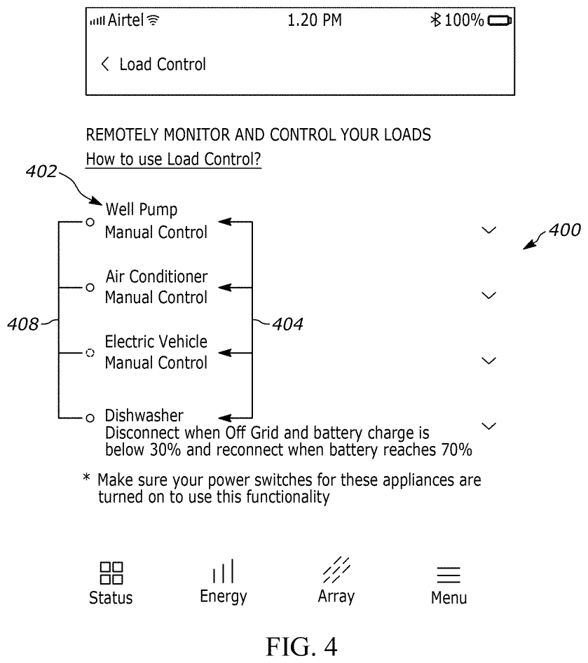

The user device 208, when executing the load control application 218, is transformed from a general-purpose device into a specific-purpose device. i.e., transformed into the load controller 202. The load control application 218, when executed, enables at least one user device 208 to access and interact with the server 204 and the distributed generator system (100 in FIG. 1). Specifically, the load control application 218 enables the user device 202 to communicate with the load control devices (124 of FIG. 1) via the network 206 and the gateway 122. The access and interaction shall be described in detail with respect to FIGS. 3 and 4.

FIG. 3 depicts a flow diagram of a method 300 that is performed upon executing a load control software application (218 of FIG. 2) in accordance with an embodiment of the invention. Using the load control software application, a user may establish parameters for load control and actively control the loads powered by the distributed energy generator system. Each block of the flow diagrams below may represent a module of code to execute and/or combinations of hardware and/or software configured to perform one or more processes described herein. Though illustrated in a particular order, the following figures are not meant to be so limiting. Any number of blocks may proceed in any order (including being omitted) and/or substantially simultaneously (i.e., within technical tolerances of processors, etc.) to perform the operations described herein.

FIG. 3 depicts a method 300 that is performed when user device 208 of FIG. 2 executes the load control application 218. The method 300 begins at 302 and proceeds to 304 where a user (typically, a homeowner or facility manager), through the user device, launches the load control application.

At 306, the method 300 may access the server and create a new load control record containing, for example, system owner information (e.g., name, address, etc.) and load details (e.g., identify each load powered by the system). If the user has previously created a record and they do not wish to make any updates to the record, the user may elect to bypass 306 and proceed to 308 as represented by path 322. Such profile information may be stored locally on the user device, transmitted to the server, or stored in the user device and server.

At 308, the method 300 displays a user interface comprising a list of the loads, a control state for each load and a current status of each load. The loads are listed by name, for example, but not limited to, well pump, air conditioner, electric vehicle, dishwasher, etc. The control state identifies the type of control that has been applied to each load. Initially, the load control state is set to manual where the user may manually control whether the load is connected to the service panel or not. The control states may depend upon the status of the grid connection (i.e., grid tied or off-grid), the amount of stored power available, whether the generator is generating power, and/or the like. The selectable control states include, but are not limited to:
1) manual control (irrespective of grid availability),
2) disconnect the load when operating off-grid and the stored power (e.g., battery charge status) is below a predefined lower level (e.g., 30% of full charge) and reconnect the load when the stored power attains a predefined upper level (e.g., 70% of full charge),
3) disconnect the load upon off-grid operation commencing, or
4) disconnect the load when operating off-grid and the generator is not producing power.
   The predefined storage levels may be user adjustable. Through a pull-down menu, the user may select critical loads to remain connected to the distributed energy generation system when the system is operating off-grid. Also, the user may conditionally connect the loads depending on whether enough power is being generated by the generator or stored in storage. Thus, a user may optimize loading of the system when operating off grid to enable the longest period of off-grid operation possible. Adjusting the storage level parameters, ensures that the storage is operated within an optimal range, i.e., batteries are not over discharged or overcharged.

The display may also indicate the load status for each load, i.e., is the load currently connected to the distributed energy generation system or not. In one embodiment, the status may be a color indicator—green for connected, red for not connected. Other indicia may be used.

At 310, the user may elect to change the control state of any of the loads. In one exemplary embodiment, the user may select a load from the list and activate a pull-down menu of selectable load control state options. If the user decides to change the state at 310, the method 300 proceeds to 312 where the method 300 displays the control state options. At 314, the user may select a control state option and set the parameters for the selected option (if necessary). For example, the user may select option 2 above and set the stored power predefined levels by typing a number representing the percentage of charge into a field. At 316, the user may select a “save” button and the method 300 saves the control state selection. The state selection and parameters may be stored in the user device, server or combination of both. At 318, the user may select another state to change and the method 300 returns to 312 to facilitate making the change. If the user has completed all the desired changes or does not wish to make any further changes at 310, the method 300 ends at 320.

To monitor load status, a user may execute the load control application and proceed to 308 to display the loads, control state and load status. The load status indicator, as described further below, provides an indication of whether particular loads are currently being powered (i.e., connected to the energy generation system or the utility grid).

FIGS. 4 through 7 depict exemplary screen images of screens created by the method 300 to support the functionality described above.

FIG. 4 depicts screen image 400 that may be used at 308 to display a list 402 of the loads that are under control, text 406 indicating the current the control state of each load, and indicia 408 of the load status of each load. Each listed load in this first display may be selected to facilitate a second display that may be manipulated to adjust the load control state of the selected load.

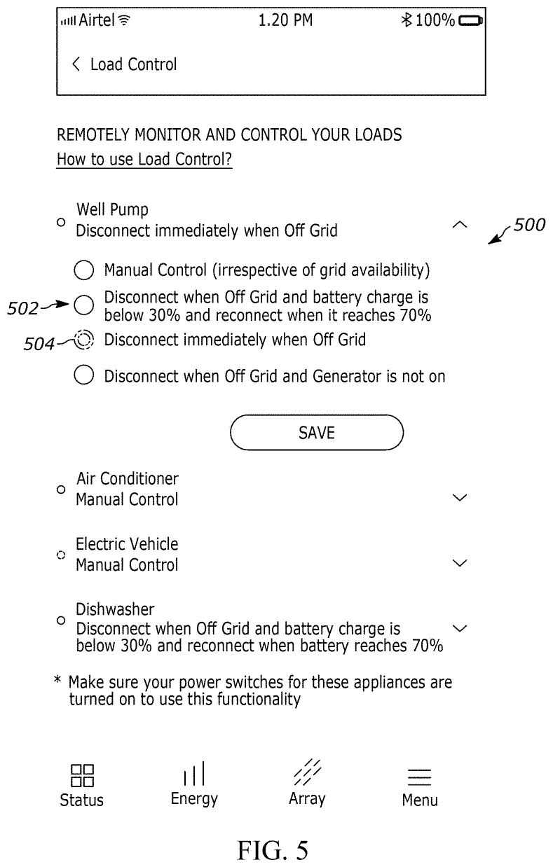

FIG. 5 depicts a screen image 500 of a display of the control state options as displayed at 312 of method 300. Screen image 500 is a second display that enables control state adjustment. The screen image 500 depicts a list 502 of selectable control state options (e.g., options 1 through 4 listed above). In one embodiment, a particular option may be selected using a radio button 504.

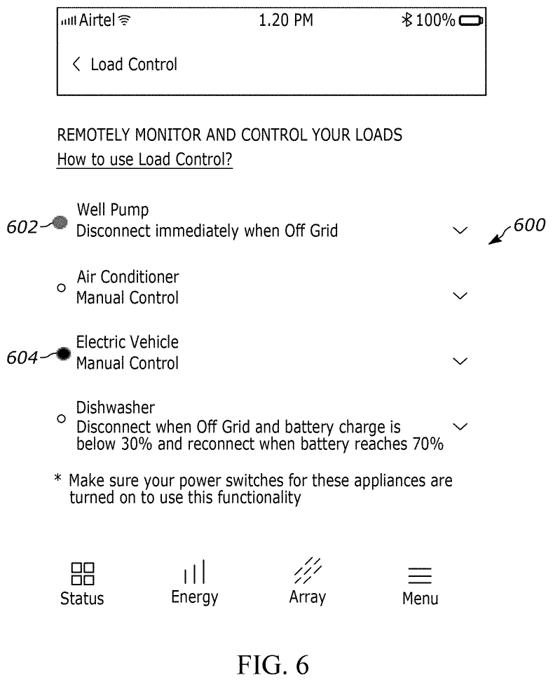

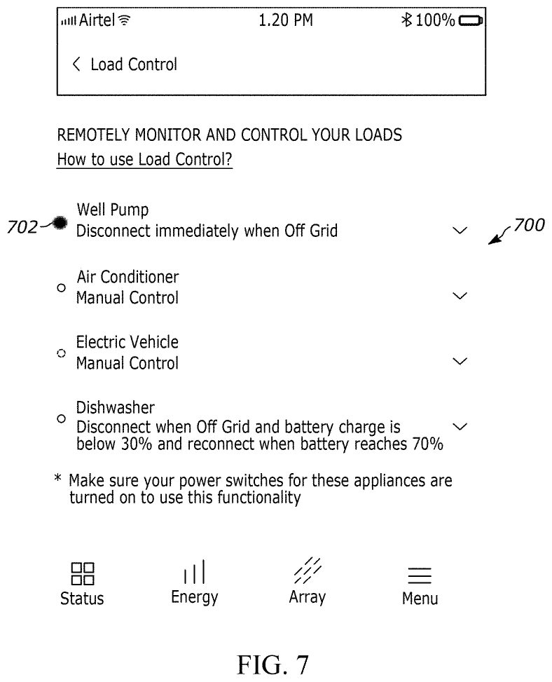

FIG. 6 depicts a screen image 600 displaying status information when the utility grid is connected and the well pump is operating, i.e., the load status indicator 602 for the well pump is “on” (green). The electric vehicle is presently not connected such that its load status indicator 604 indicates “off” (red). FIG. 7 depicts a screen image 700 displaying status information when the utility grid is not connected (off-grid operation) and the well pump is off, i.e., the load status indicator 702 for the well pump is “off” (red) indicating the well pump is disconnected from the distributed energy generation system in accordance with its load control parameters.

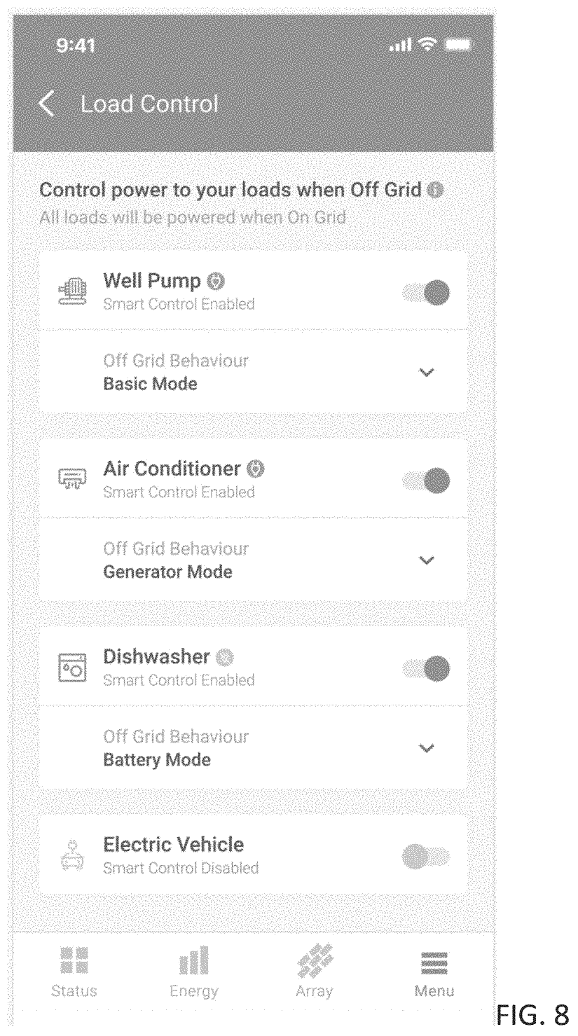

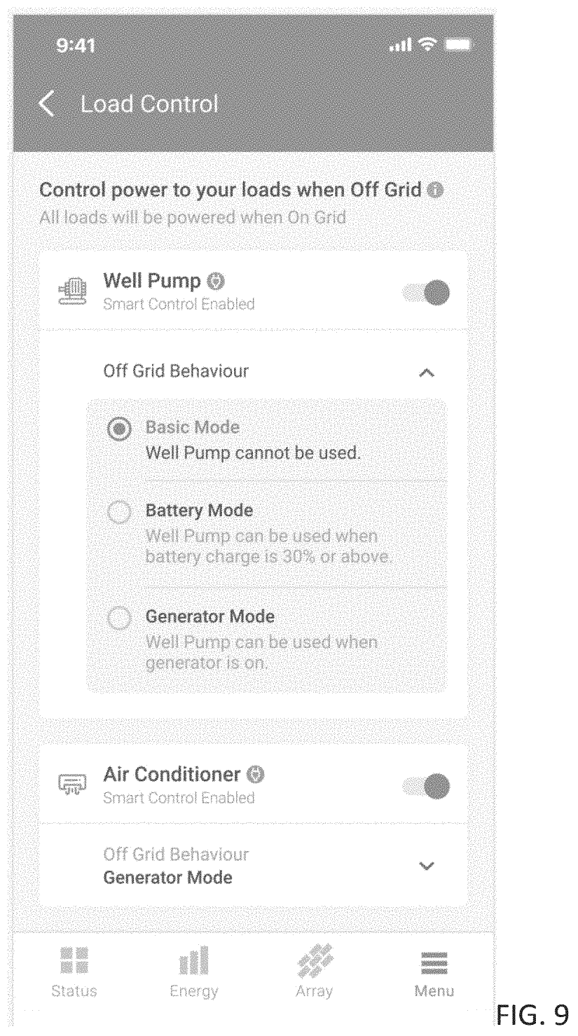

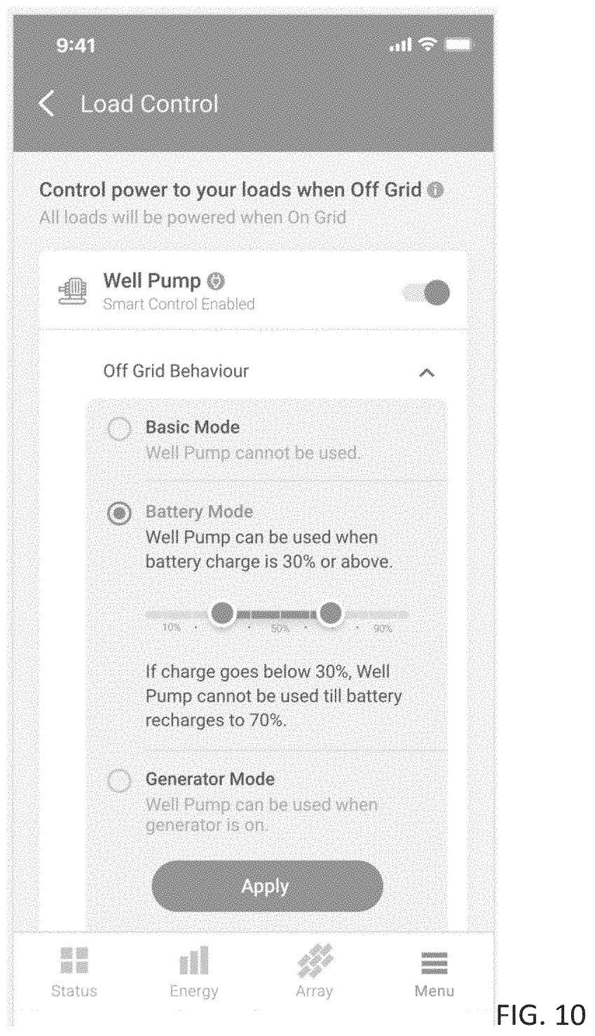

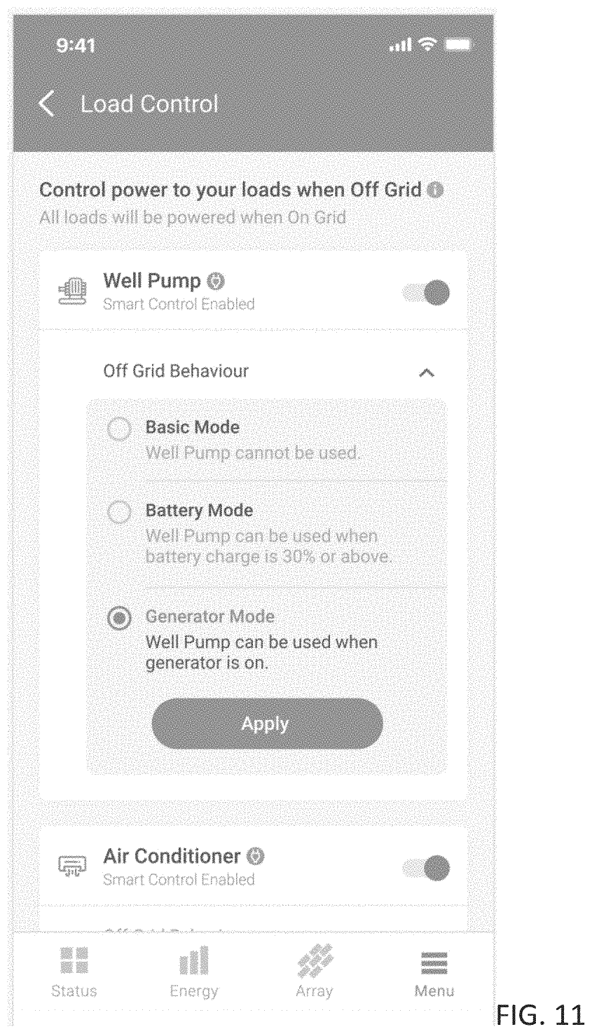

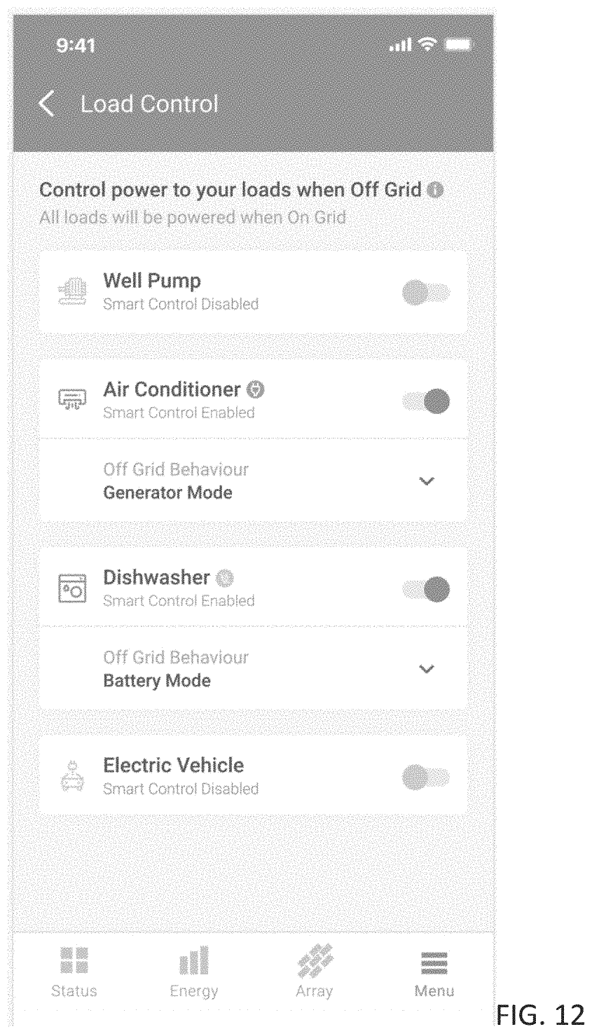

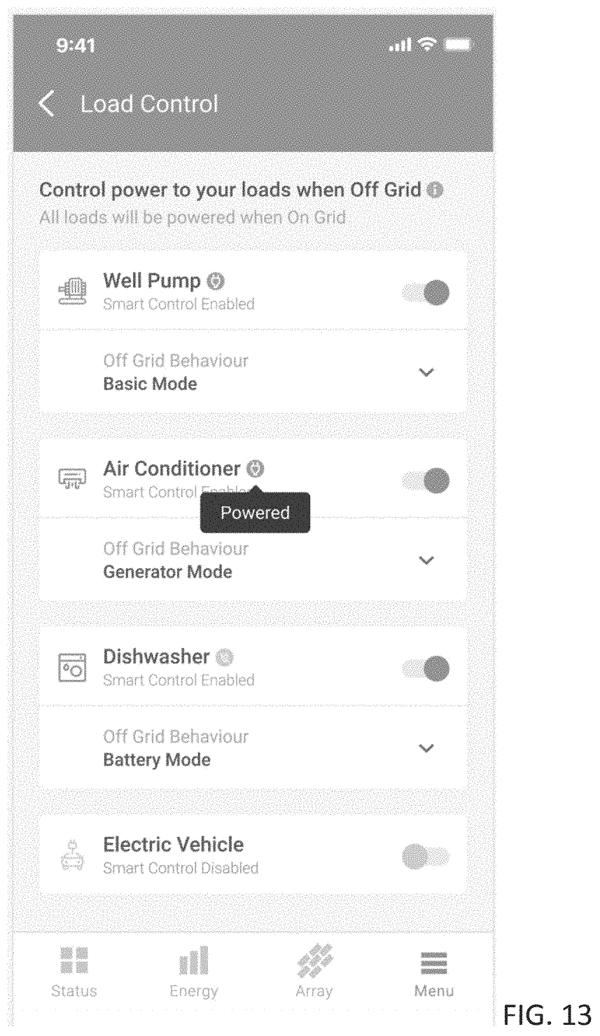

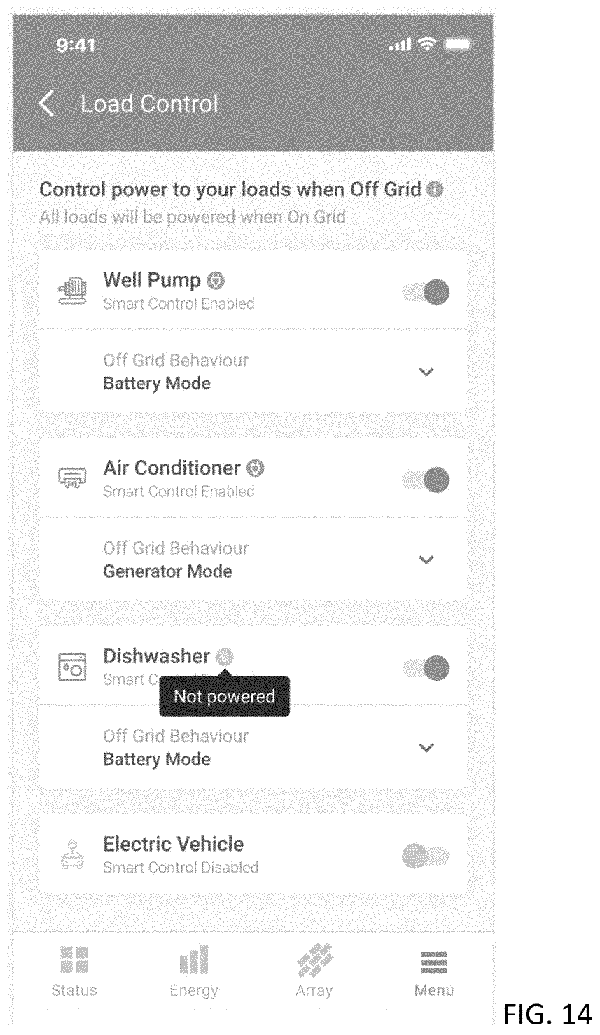

FIGS. 8-14 depict screen images on a user device displaying a user interface to the load control method of FIG. 3 in accordance with another embodiment of the invention. Here, selection of appliances is accomplished using slider buttons rather than radio buttons. Also, a device that is powered is accompanied by an icon (e.g., a green icon) as in FIG. 13 and device that is not powered is accompanied by a different icon (e.g., a red icon) as in FIG. 14. In FIG. 10, note the battery mode control is adjusted using a slider on a scale of 0% to 100%. Thus, a user may control the percentage of battery charge required before a device is to be used (e.g., the well pump can be used when battery charge is above 30%, but if the charge falls below 30%, then do not use the well pump until the battery is recharged to 70%).

Here multiple examples have been given to illustrate various features and are not intended to be so limiting. Any one or more of the features may not be limited to the particular examples and embodiments presented herein, regardless of any order, combination, or connections described. In fact, it should be understood that any combination of the features and/or elements described by way of example above are contemplated, including any variation or modification which is not enumerated, but capable of achieving the same. Unless otherwise stated, any one or more of the features may be combined in any order.

As above, figures are presented herein for illustrative purposes and are not meant to impose any structural limitations, unless otherwise specified. Various modifications to any of the structures shown in the figures are contemplated to be within the scope of the invention presented herein. The invention is not intended to be limited to any scope of claim language.

Where “coupling” or “connection” is used, unless otherwise specified, no limitation is implied that the coupling or connection be restricted to a physical coupling or connection and, instead, should be read to include communicative couplings, including wireless transmissions and protocols.

Any block, step, module, or otherwise described herein may represent one or more instructions which can be stored on a non-transitory computer readable media as software and/or performed by hardware. Any such block, module, step, or otherwise can be performed by various software and/or hardware combinations in a manner which may be automated, including the use of specialized hardware designed to achieve such a purpose. As above, any number of blocks, steps, or modules may be performed in any order or not at all, including substantially simultaneously, i.e., within tolerances of the systems executing the block, step, or module.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

Where lists are enumerated in the alternative or conjunctive (e.g., one or more of A, B, and/or C), unless stated otherwise, it is understood to include one or more of each element, including any one or more combinations of any number of the enumerated elements (e.g. A, AB, AB, ABC, ABB, etc.). When “and/or” is used, it should be understood that the elements may be joined in the alternative or conjunctive.

While the foregoing is directed to embodiments of the present invention, other and further embodiments of the invention may be devised without departing from the basic scope thereof, and the scope thereof is determined by the claims that follow.

1. Apparatus for controlling loads connected to a distributed energy generation system comprising:
a user device comprising:
one or more processors coupled to one or more non-transitory computer readable media storing instructions thereon which, when executed by the one or more processors, cause the one or more processors to perform the operations comprising:
determining a load control state for one or more loads connected to a distributed energy generation system;
displaying, on the user device, a list of the one or more loads and a load control state for each load in the list; and
adjusting, through manipulation of a user interface displayed on the user device, the load control state for at least one load in the list.

2. The apparatus of claim 1, wherein the load control state for at least one load depends upon at least one of (1) a status of a grid connection for the distributed energy generation system, (2) an energy storage status for energy storage within the distributed energy generation system, or both (1) and (2).

3. The apparatus of claim 2 wherein the energy storage status is an amount of charge stored in a battery and the load control state is established to disconnect a load when the charge is below a predefined lower level and reconnect the load when the charge is above a predefined upper level.

4. The apparatus of claim 3, wherein the predefined upper level and predefined lower level are adjustable through manipulation of the user interface.

5. The apparatus of claim 4, wherein the manipulation of the user interface to adjust the predefined upper level and the predefined lower level is through manipulation of a slider.

6. The apparatus of claim 1, wherein the user interface is manually controlled to set the load control state for at least one load.

7. The apparatus of claim 1, wherein the load control state for at least one load disconnects the at least one load upon the distributed energy generation system commencing an off-grid operation.

8. The apparatus of claim 1, wherein the load control state for at least one load disconnects the at least one load upon the distributed energy generation system commencing an off-grid operation and the distributed energy generation system not producing power.

9. A method for controlling loads connected to a distributed energy generation system comprising:
determining a load control state for one or more loads connected to a distributed energy generation system;
displaying, on the user device, a list of the one or more loads and a load control state for each load in the list; and
adjusting, through manipulation of a user interface displayed on the user device, the load control state for at least one load in the list.

10. The method of claim 9, wherein the load control state for at least one load depends upon at least one of (1) a status of a grid connection for the distributed energy generation system, (2) an energy storage status for energy storage within the distributed energy generation system, or both (1) and (2).

11. The method of claim 10, wherein the energy storage status is an amount of charge stored in a battery and the load control state is established to disconnect a load when the charge is below a predefined lower level and reconnect the load when the charge is above a predefined upper level.

12. The method of claim 11, wherein the predefined upper level and predefined lower level are adjustable through manipulation of the user interface.

13. The method of claim 12, wherein the manipulation of the user interface to adjust the predefined upper level and the predefined lower level is through manipulation of a slider.

14. The method of claim 9, wherein the user interface is manually controlled to set the load control state for at least one load.

15. The method of claim 9, wherein the load control state for at least one load disconnects the at least one load upon the distributed energy generation system commencing an off-grid operation.

16. The method of claim 9, wherein the load control state for at least one load disconnects the at least one load upon the distributed energy generation system commencing an off-grid operation and the distributed energy generation system not producing power.

17. A user interface for controlling loads connected to a distributed energy generation system comprising:
a first display including:
a list of a plurality of loads;
a control state of each load in the list;
a load status for each load in the list; and
upon selection of a specific load in the list, a second display including:
a list of control state options that may be selected and/or manipulated to alter the control state of the selected load.

18. The user interface of claim 17, wherein the list of control state options comprise a manipulatable control comprising at least one of a radio button, a slider button, or a slider.

19. The user interface of claim 17, wherein the list of control state options comprises:
a first load state that enables manual control of the selected load irrespective of grid availability;
a second load state of the selected load that depends upon an energy storage status for energy storage within the distributed energy generation system;
a third load state that disconnects the selected load upon the distributed energy generation system commencing an off-grid operation; and
a fourth load option that disconnects the at least one load upon the distributed energy generation system commencing an off-grid operation and the distributed energy generation system not producing power.

20. The user interface of claim 19, wherein the energy storage status is an amount of charge stored in a battery and the load control state is established to disconnect a load when the charge is below a predefined lower level and reconnect the load when the charge is above a predefined upper level.
